(19) United States
(12) Patent Application Publication
(10) Pub. No.: US 2011/0284526 A1
(43) Pub. Date: Nov. 24, 2011

(54) CLAMPING APPARATUS AND METHOD OF HEAT-TREATING A LONG MATERIAL

(75) Inventor: Rafael Garcia Gomez, Paderborn (DE)

(73) Assignee: Benteler Automobiltechnik GmbH, Paderborn (DE)

(21) Appl. No.: 13/101,683

(22) Filed: May 5, 2011

(30) Foreign Application Priority Data
May 19, 2010 (DE) 102010020942.2-24

(51) Int. Cl. H05B 6/10; C21D 1/667; C21D 1/78

(52) U.S. Cl. 219/647; 266/129

(57) ABSTRACT

Apparatus for heat treatment of a long material of metal includes an induction unit having an inductor for heating a long material and a quenching spray associated to the inductor. The induction unit and the long material are moveable in relation to one another during a heat treatment. A holding device secures the long material and includes at least two clamping units which are spaced from one another at a distance in a longitudinal direction of the long material. The clamping units can be opened to allow passage of the induction unit during the heat treatment and closed again after passage of the induction unit.

### CROSS-REFERENCES TO RELATED APPLICATIONS

This application claims the priority of German Patent Application, Serial No. 10 2010 020 942.2, filed May 19, 2010, pursuant to 35 U.S.C. 119(a)-(d), the content of which is incorporated herein by reference in its entirety as if fully set forth herein.

### BACKGROUND OF THE INVENTION

The present invention relates to an apparatus and method for heat-treating of long material.

The following discussion of related art is provided to assist the reader in understanding the advantages of the invention, and is not to be construed as an admission that this related art is prior art to this invention.

Induction hardening devices for hardening elongated workpieces, such as axle shafts, cardan shafts, tubes for a roof railing, or stabilizers for motor vehicles, typically have loop-type inductors and quenching sprays which are associated to the loop-type inductors. For many applications, the progressive hardening method and the method for hardening the entire surface of a workpiece have been used in the past. There is a tendency however to provide more flexibility when constructing machine tools.

Batch sizes of individual workpiece types become increasingly smaller, whereas retrofitting using conventional methods is time consuming and rises in proportion. Therefore, a switch to other workpiece types and tools is automated.

Both, the method for hardening the entire surface of a workpiece and the progressive hardening method can be used to harden substantially elongated and straight workpieces. Elongated workpieces that are nonlinear, e.g. in the form of a free-flowing line or curved patterns, progressive hardening is better suitable for automation. In both hardening methods or during heat treatment, hardening begins at one end of the long material at a standstill heat-up time of few seconds, which is then followed by the advance movement. However, residual stress causes unavoidable structural distortions during hardening or after removal from the hardening device. The distortion may also be encountered in the form of relaxations, caused by residual stress. Hardening may in some situations result in dimensional changes of batches outside the permissible production tolerances.

It would therefore be desirable and advantageous to address prior art problems and to obviate other prior art shortcomings.

### SUMMARY OF THE INVENTION

According to one aspect of the present invention, an apparatus for heat treatment of a long material of metal includes an induction unit having an inductor for heating a long material and a quenching spray associated to the inductor, the induction unit and the long material being moveable in relation to one another during a heat treatment, and a holding device for securing the long material, the holding device including at least two clamping units spaced from one another at a distance in a longitudinal direction of the long material, with the clamping units being movable between an open position for allowing passage of the induction unit during the heat treatment and a closed position after passage of the induction unit.

In the following description, a relative movement between long material and induction unit is to be understood as involving either a movement of the induction unit longitudinally along the long material or a movement of the long material with the entire tool clamping device along the induction unit. This may involve, for example, keeping the induction unit stationary while rendering the apparatus for heat treatment with the clamped long material movable. Also conceivable is a combination in which each of the induction unit and the apparatus with clamped long material is able to carry out a movement to attain the relative movement between long material and induction unit.

Metal as used in the description may include any metallic material, for example metals on the basis of a magnesium alloy, titanium alloy, or the like. Also a light metal alloy is included here, e.g. aluminum alloy. Currently preferred is the use of a steel material, although other metallic alloys are not excluded.

When moving the induction unit in longitudinal direction relative to the long material, the clamping unit opens as soon as the long material approaches the clamping unit. The opened clamping unit clears the way for the induction unit to continue to travel in longitudinal direction relative to the long material. After the induction unit has passed a length portion of the long material in the area of the clamping unit, the clamping unit closes again. The long material is heated by the passing induction unit and hardened as a result of a rapid quenching by the quenching spray. Clamping the long material by the clamping unit during the cooldown phase is beneficial because any deformations caused by residual stress during hardening can be controlled.

An apparatus for heat treatment of long material in accordance with the present invention can advantageously be integrated in an automated production process. This lowers operating costs and provides a cost-efficient alternative to conventional hardening methods.

According to another advantageous feature of the present invention, the holding device can secure the long material in vertical orientation. This is advantageous because the cooling fluid which is applied by the quenching spray onto the long material is able to flow along the long material as a result of the vertical orientation. When the inductor travels in relation to the vertical plane from bottom to top, better utilization of the cooling fluid is being made. The newly applied cooling fluid flows across already quenched areas, causing added cooling action. As a result, use of cooling fluid is reduced. Moreover, cooling fluid can be collected nearly centrally below the long material so that there is no need for providing the overall apparatus with an expansive cooling pan for collecting cooling fluid.

According to another advantageous feature of the present invention, the clamping units can be constructed to circumferentially embrace at least one section of the long material. In this way, the long material can be held in correct desired position. The clamping units can be operated multifunctional. For example, a multi-purpose clamping unit can be used to receive long materials of most different cross sectional areas, without requiring a tool change. A clamping unit may, for example, be used to embrace a substantially circular long material of different diametrical dimensions.

Long materials having different diameters and/or diametrical cross sections can be clamped multifunctionally in a clamping unit. These diametrical cross sections may involve round, oval, circular, polygonal, or combinations thereof. An apparatus according to the present invention may also be used for processing hydro-formed structures that have different diametrical geometries and/or diametrical dimensions along the longitudinal direction.

According to another advantageous feature of the present invention, each clamping unit may include two clamps, at least one of the clamps being swingably mounted. The swinging support allows an optimal integration of the clamp, as component of the clamping units, in an automated production process. Examples of a swinging support include a toggle lever mechanism or the use of a head of tongs. The term “clamp” relates hereby to any tool which includes a load-bearing member and/or a clamping jaw.

According to another advantageous feature of the present invention, each clamp or each clamping unit may include an actuator to effect the open and closed positions of the clamps or clamping units. The term “actuator” relates hereby to any actuator that can be operated pneumatically, hydraulically, electromagnetically, or electromechanically. Examples include a servo motor or a stepper motor, although other types of control are, of course, also possible. The actuator triggers a pivoting of the clamping unit with two clamps. Currently preferred is a clamping unit with two clamps configured with a toggle lever mechanism. A configuration in the form of a crimping pliers, as known in the prior art for sleeve compression, may also be used.

According to another advantageous feature of the present invention, the clamping units can be operated independently from one another with respect to the open and closed positions. “Separate opening” relates hereby to the fact that the individual clamping units can be opened and closed independently from one another. It is therefore conceivable, for example, to provide three or more clamping units for clamping a long material. Currently the presence of five or more clamping units is preferred. As the induction unit travels past the long material, a scenario is for example conceivable in which, depending on the speed of traverse of the induction unit, a next clamping unit is opened and the next following clamping unit commences the opening process, whereas the clamping unit that has been previously passed by the induction unit undergoes a closing process. This kind of control is individually adjustable and can be carried out separately for each clamping unit.

According to another advantageous feature of the present invention, the clamping units can be opened and closed during the heat treatment in dependence on a position of the induction unit, with one of the clamping units assuming the open position for passage of the induction unit while the other one of the clamping units adjacent to the one clamping unit assuming the closed position. In accordance with the present invention, one of two clamping units has to be closed to prevent the workpiece from being knocked out. In the presence of several clamping units, for example three or four or five or even seven or more clamping units, it is advantageous when a neighboring clamping unit is kept closed to prevent unwanted deformation as a result of residual stress. Currently preferred is a scenario in which a leading and trailing clamping unit is kept closed, as viewed in traverse direction.

According to another aspect of the present invention, a method of heat treating a long material includes the steps of clamping a long material by at least two clamping units, moving an induction unit and the long material in relation to one another in longitudinal direction of the long material, opening at least one of the clamping units for allowing passage of the induction unit in the longitudinal direction of the long material, and closing the at least one of the clamping units after passage of the induction unit.

In accordance with the present invention, at least two clamping units are used, with the clamping units being arranged substantially in a region of end portions of the long material. When the long material is secured in place, an induction unit is moved in relation to the long material. It is, of course, also possible to keep the induction unit stationary and to move the clamped long material. As soon as the induction unit approaches a clamping unit, the clamping unit opens to allow the induction unit to move past the length portion of the long material situated at a level of the clamping unit. After the induction unit has passed the length portion, the clamping unit is closed again.

A method according to the present invention has the advantage of allowing a control of any structural deformation or also structural shrinkage of the long material during the production process. By securing the long material in a predefined desired geometry, production tolerances can be kept within especially narrow limits. Thus, a method according to the present invention provides the opportunity to harden long material in a particularly cost-efficient manner with a minimum of waste.

According to another advantageous feature of the present invention, the clamping unit which holds the length portion of the long material can be opened before the induction unit reaches the clamping unit. This ensures a continuous, suitably linear speed of traverse of the induction unit. There is no interruption in the advance. This has an especially beneficial effect on the microstructure within the material of the long material as established by hardening as a result of an even the heat treatment with the inductor.

According to another advantageous feature of the present invention, the clamping unit can be closed after the induction unit has passed the length portion of the long material. Closing the clamping unit again keeps the length portion and the long material in the desired geometry. The possibility of any deformation, caused by residual stress during hardening, is therefore substantially avoided. The closing operation is also beneficial because the long material can be shaped into the desired geometry while it has not yet fully hardened.

According to another advantageous feature of the present invention, the clamping units can clamp the long material in the desired target geometry. By positionally fixing the long material, the target geometry before, during, and after hardening is maintained. There is no structural shrinkage or deformation in accordance with the method of the invention.

According to another advantageous feature of the present invention, the clamping units can clamp the long material in a position which deviates from the desired target geometry, and the long material is allowed to undergo a desired deformation after release of the long material from the clamping units to assume a final configuration. Release of the long material may hereby be carried out either during a quenching and tempering process or after conclusion of the quenching and tempering process. By intentionally causing residual stress in the structure, the structure assumes its desired geometry after release. Of course, it is also possible that one or more clamping units are no longer closed after opening once the induction unit has passed.

According to another advantageous feature of the present invention, a clamping unit which neighbors the opened clamping unit is kept closed at all times. This ensures that the structure is held by at least one clamping unit in the desired position.

According to another advantageous feature of the present invention, the long material can be clamped by three or more clamping units, with the clamping units being opened or closed separately or in groups. Depending on the application at hand, it may be advantageous to open and close each clamping unit separately and by itself or to control clamping unit in groups for example.

In the presence of three clamping units, two clamping units may for example be opened or closed simultaneously, while the third clamping unit is kept closed. This may positively affect the hardening process depending on the application at hand. For example in the event of a desired deformation, it may be advantageous to release a group of clamping units and to no longer close it after hardening.

A common control which includes a time-staggered interval, may also be conceivable. For example, one clamping unit may be opened to allow passage of the induction unit, while the following clamping unit is also in the process of being opened at a time-staggered sequence.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic perspective illustration of an apparatus for heat treatment of long material in accordance with the present invention in an open state;

FIG. 2 is a detailed perspective view on an enlarged scale of the apparatus in clamped state and depicting the provision of an induction unit;

FIG. 3 shows schematically a detailed perspective view of the apparatus, illustrating a further method sequence for hardening;

FIG. 4 is a schematic perspective illustration of the apparatus before opening a clamping unit for hardening long material;

FIG. 5 is a schematic perspective illustration of the apparatus during opening of a clamping unit for hardening long material;

FIG. 6 is a schematic perspective illustration of the apparatus after opening of a clamping unit for hardening long material; and

FIG. 7 is a schematic perspective illustration of the apparatus after an induction unit has passed a clamping unit.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

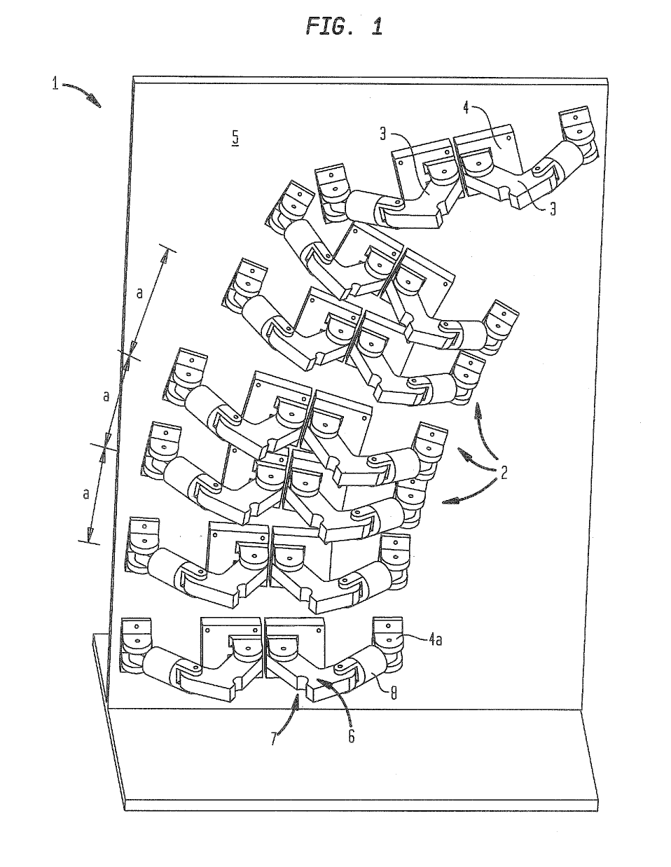

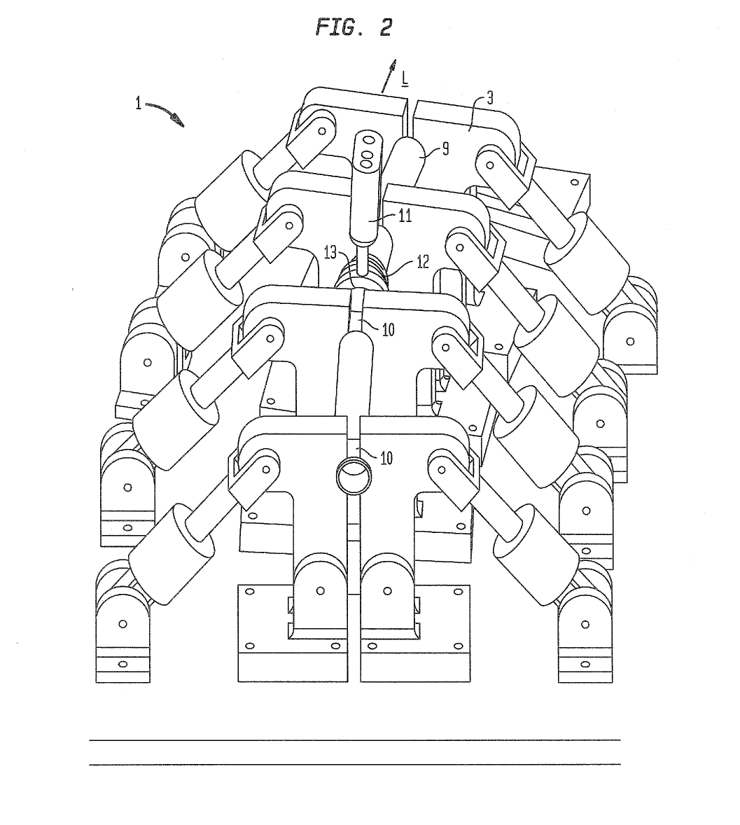

Turning now to the drawing, and in particular to FIG. 1, there is shown a schematic perspective illustration of an apparatus according to the present invention, generally designated by reference numeral 1, for heat treatment of long material 9 (FIG. 2). The apparatus 1 includes several clamping units 2 arranged in a vertical orientation and spaced from one another by a variable distance “a”. Each of the clamping units 2 has two clamps 3 which in turn are configured in the form of a toggle lever mechanism. Each clamp 3 is swingably arranged on a machine base 5 for pivoting about a fixed bearing 4. The clamp 3 has a clamp body 6 and a clamping jaw 7 arranged on the clamp body 6. An actuator 8 is also arranged on the clamp 3 and supported on the machine base 5 for rotation about a fixed bearing 4a. The apparatus 1 for heat treatment of long material 9 is shown in FIG. 1 in a state in which all clamping units 2 are open.

FIG. 2 is a detailed perspective view on an enlarged scale of the apparatus of FIG. 1 for heat treatment, with the long material 9 being clamped. The long material 9 is clamped by the clamps 3 between the clamping jaws 7. At least some areas of length portions 10 of the long material 9 are hereby embraced by the clamps 3. The length portions 10 extend in longitudinal direction L of the long material 9. FIG. 2 further shows the presence of an induction unit 11 which includes an inductor 12 and a quenching spray 13 associated to the inductor 12. The induction unit 11 is operably connected to a not shown movement mechanism, for example a robotic arm or the like.

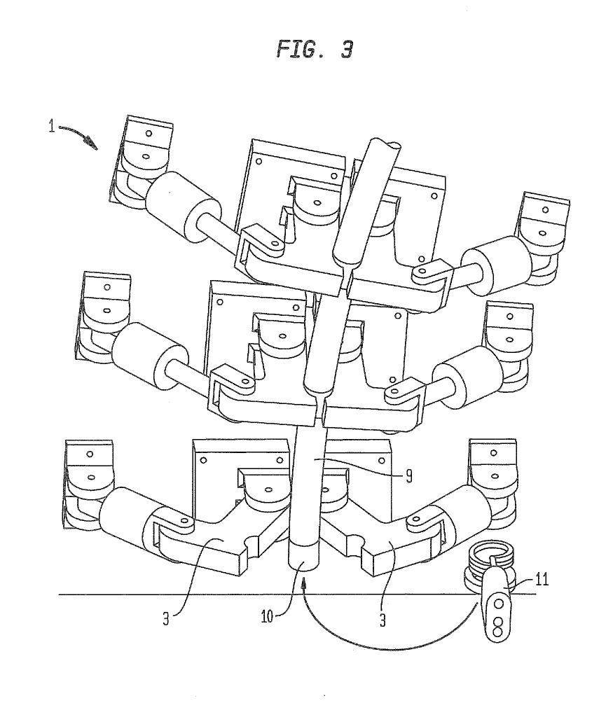

FIG. 3 shows schematically a detailed perspective view of the apparatus 1 for heat treatment. In the method step shown in FIG. 3, the induction unit 11 is not yet in engagement with the long material 9. The induction unit 11 is moved from an idle position to a starting position in aligned orientation with the longitudinal direction L, as indicated by the arrow. In the illustrated example of FIG. 3, a length portion 10 is visible at the end of the long material 9 and about to be clamped by a clamp 3 which is still in an open position to allow the induction unit 11 to pass the length portion 10. The other clamping units 2 following in longitudinal direction L assume their closed position so that the long material 9, i.e. the respective length portions 10, are held in place.

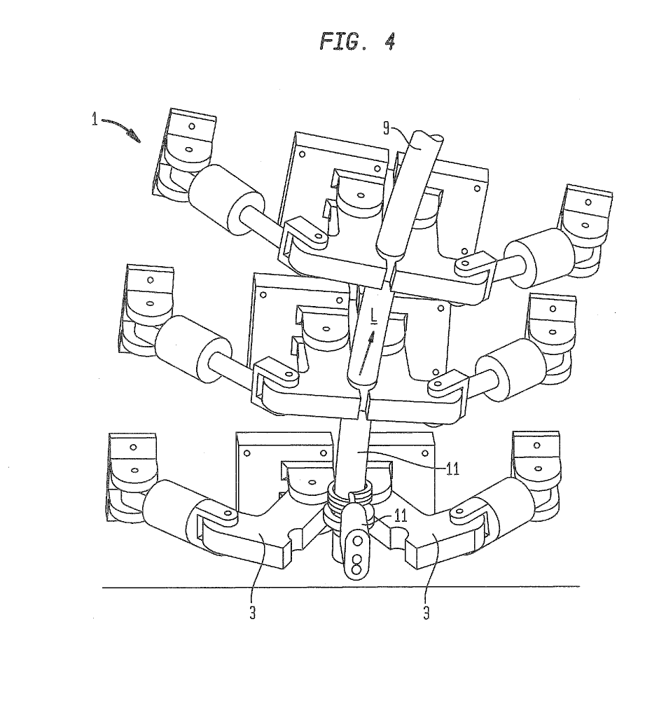

FIG. 4 shows a further progressed method sequence compared to the situation shown in FIG. 3. The induction unit 11 is now in engagement with the long material 9 and has already passed the still open clamping unit 2 which is positioned relative to the length portion 10 at the end of the long material 9. The induction unit 11 continues to advance in longitudinal direction L along the long material 9.

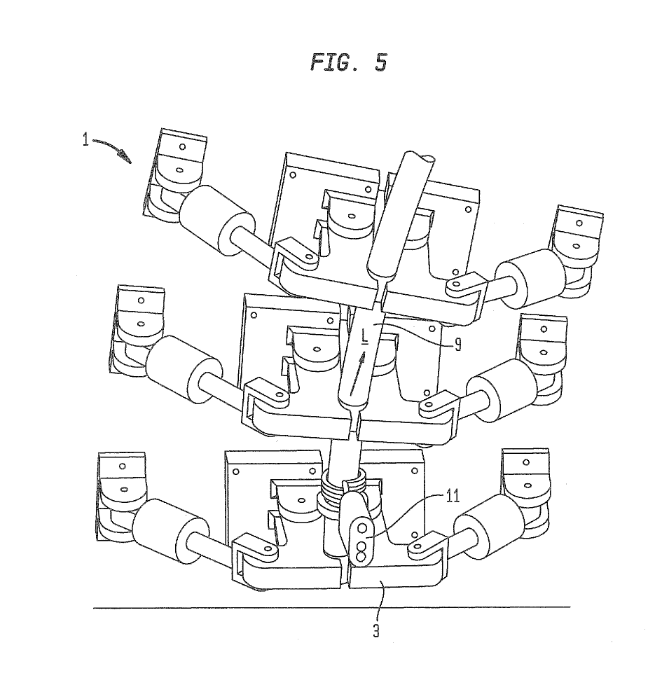

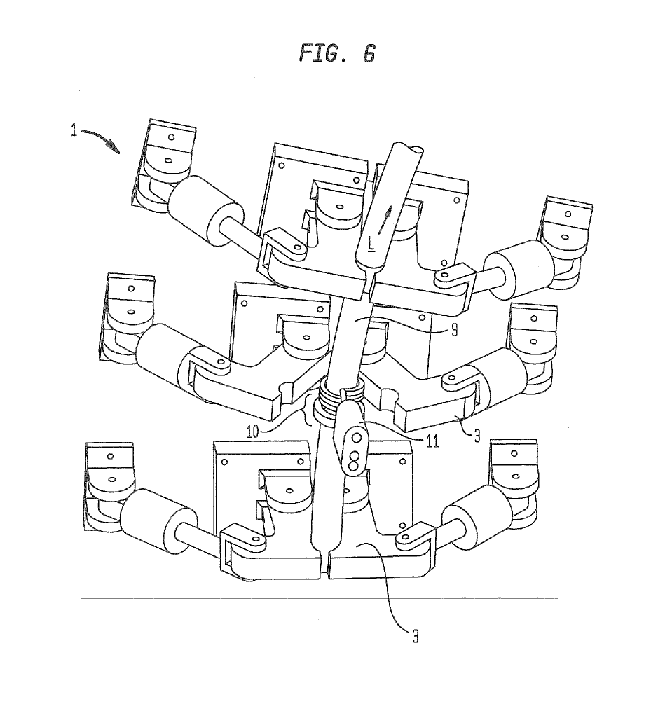

FIG. 5 shows the still further advanced situation of the method sequence, whereby the clamping unit 2 at the end of the long material 9 has now been closed. The induction unit 11 is positioned in a transition area between two neighboring closed clamping unit 2 and continues its advance in longitudinal direction L of the long material 9. As the induction unit 11 approaches the next (second) clamping unit 2 of the apparatus 1 for heat treatment of long material 9, this clamping unit 2 is now opened, as shown in FIG. 6. As a result, the induction unit 11 is now able to pass the length portion 10 positioned in this clamping unit 2.

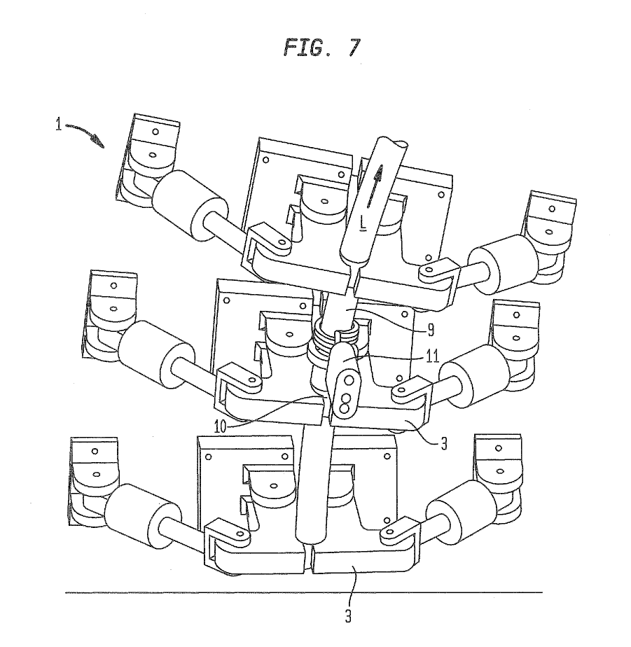

FIG. 7 shows the induction unit 11 having passed the length portion 10 in the second clamping unit 2 so that the second clamping unit 2 has now been closed.

As the method steps shown in FIGS. 4 to 7 illustrate, the clamping units 2 can be opened and closed sequentially independently from one another. Of course, individual clamping units 2 may be combined into groups which can then be opened and closed at a same time or in a time-staggered sequence.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for heat treatment of a long material of metal, comprising:
an induction unit including an inductor for heating a long material and a quenching spray associated to the inductor, said induction unit and the long material being moveable in relation to one another during a heat treatment; and
a holding device for securing the long material, said holding device including at least two clamping units spaced from one another at a distance in a longitudinal direction of the long material, said clamping units being movable between an open position for passage of the induction unit during the heat treatment and a closed position after passage of the induction unit.

2. The apparatus of claim 1, wherein the metal is a steel material.

3. The apparatus of claim 1, wherein the holding device secures the long material in vertical orientation.

4. The apparatus of claim 1, wherein the clamping units are constructed to circumferentially embrace at least one section of the long material.

5. The apparatus of claim 1, wherein each said clamping unit includes two clamps, at least one of the clamps being swingably mounted.

6. The apparatus of claim 5, further comprising actuators operably connected to the clamps in one-to-one correspondence to effect the open and closed positions of the clamps.

7. The apparatus of claim 1, further comprising actuators operably connected to the clamping units in one-to-one correspondence to effect the open and closed positions of the clamping units.

8. The apparatus of claim 1, wherein the clamping units are operated independently from one another with respect to the open and closed positions.

9. The apparatus of claim 1, wherein the clamping units effect the open and closed positions during the heat treatment in dependence on a position of the induction unit, with one of the clamping units assuming the open position for passage of the induction unit while the other one of the clamping units adjacent to the one clamping unit assuming the closed position.

10. A method of heat treating a long material, comprising the steps of:
clamping a long material by at least two clamping units;
moving an induction unit and the long material in relation to one another in longitudinal direction of the long material;
opening at least one of the clamping units for allowing passage of the induction unit in the longitudinal direction of the long material; and
closing the at least one of the clamping units after passage of the induction unit.

11. The method of claim 10, wherein the at least one of the clamping units secures a length portion of the long material and is opened before the induction unit reaches the at least one of the clamping units.

12. The method of claim 10, wherein the at least one of the clamping units is closed after the induction unit has passed a length portion of the long material.

13. The method of claim 10, wherein the clamping units clamp the long material in a desired target geometry.

14. The method of claim 10, wherein the clamping units clamp the long material in a position which deviates from a desired target geometry, and further comprising the step of allowing the long material to undergo a desired deformation after release of the long material from the clamping units to assume a final configuration.

15. The method of claim 10, wherein the other one of the clamping units is kept closed at all times.

16. The method of claim 10, wherein the long material is clamped by three clamping units, with the clamping units being opened or closed separately or in groups.
